(19) United States
(12) Patent Application Publication
(10) Pub. No.: US 2025/0259092 A1
(43) Pub. Date: Aug. 14, 2025

(54) Performing Quantum-Assisted Greedy Algorithms Using Hybrid Computing Systems

(71) Applicant: Rigetti & Co, LLC, Berkeley, CA (US)

(72) Inventor: Maxime Dupont, Berkeley, CA (US)

(73) Assignee: Rigetti & Co, LLC, Berkeley, CA (US)

(21) Appl. No.: 19/193,691

(22) Filed: Apr. 29, 2025

Related U.S. Application Data
(63) Continuation of application No. PCT/US2023/036586, filed on Nov. 1, 2023.
(60) Provisional application No. 63/381,831, filed on Nov. 1, 2022.
(60) Provisional application No. 63/487,898, filed on Mar. 2, 2023.

(51) Int. Cl. G06N 10/60

(52) U.S. Cl. CPC G06N 10/60

(57) ABSTRACT

In a general aspect, execution of programs embodying greedy algorithms and, in more particular, to hybrid quantum systems capable of utilizing quantum computing to assist the execution of programs embodying greedy algorithms. In some cases, a method for generating an output of an optimization problem includes causing, via a communication channel, a quantum resource to execute a quantum-based algorithm corresponding to the optimization problem; obtaining, via the communication channel, quantum results based on data generated by the execution of the quantum-based algorithm, the quantum results being indicative of one or more solutions to the optimization problem as determined by the quantum-based algorithm; based on the quantum results, selecting, by a classical computing system, an unassigned element of the output; determining, by the classical computing system, a value for the selected unassigned element of the output; and returning the output with the determined value.

### CROSS-REFERENCE TO RELATED APPLICATIONS

This application claims priority to U.S. Provisional Patent Application No. 63/381,831, filed Nov. 1, 2022, entitled “Hybrid Quantum Systems and Methods for Quantum Assisted Execution of Greedy Algorithms;” and to U.S. Provisional Patent Application No. 63/487,898, filed Mar. 2, 2023, entitled “Hybrid Quantum Systems and Methods for Quantum Assisted Execution of Greedy Algorithms.” The above-referenced priority documents are incorporated herein by reference in their entireties.

### GOVERNMENT SUPPORT

This invention was made with Government support under agreement No. HR00112090058, awarded by DARPA. The Government has certain rights in the invention.

### TECHNICAL FIELD

The following description relates generally to execution of programs embodying greedy algorithms and, in more particular, to executing quantum-assisted greedy algorithms using hybrid classical-quantum computing systems.

### BACKGROUND

Quantum computers can perform computational tasks by storing and processing information within quantum states of quantum systems. For example, qubits (i.e., quantum bits) can be stored in, and represented by, an effective two-level sub-manifold of a quantum coherent physical system. A variety of physical systems have been proposed for quantum computing applications. Examples include superconducting circuits, trapped ions, spin systems, and others.

### BRIEF DESCRIPTION OF THE DRAWINGS

FIG. 1 is a block diagram of an example computing environment.

FIG. 2 is a flow chart showing aspects of an example process.

FIG. 3 is a flow chart showing aspects of an example process.

FIG. 4 is a flow chart showing aspects of an example process.

FIG. 5 is a flow chart showing aspects of an example process.

FIG. 6 is a schematic diagram showing a scoring function.

FIG. 7 is a flow chart showing aspects of an example process.

FIG. 8 is a schematic diagram showing aspects of an example binary optimization problem mapped onto qubit devices in a quantum processing unit.

FIG. 9 is a block diagram showing aspects of an example quantum logic circuit.

FIG. 10 is an exemplary plot showing the approximation ratio as a function of the iteration step for different models including a random sampling algorithm, a classical greedy algorithm, and a quantum-guided greedy algorithm.

FIG. 11 is an exemplary plot showing the approximation ratio at the last step as a function of problem size N for different models including a random sampling algorithm, a classical greedy algorithm, and a quantum-guided greedy algorithm.

FIG. 12 is an exemplary plot showing the approximation ratio as a function of the size of the problem for different models including a Zeno dynamics embedded QAOA algorithm, quantum-guided greedy algorithms with and without hard constraints (filter), and classical greedy algorithms with and without hard constraints (filter).

### DETAILED DESCRIPTION

In some aspects of what is described here are methods, systems, and apparatuses for improving the performance of an executable embodying a greedy algorithm with results derived from a quantum computing system. In some implementations, such improvements may involve incorporating results from executing a quantum-based algorithm, as may be performed by a quantum computer system, along with the executional steps of the greedy algorithm.

To begin, a “greedy algorithm,” as used herein, may refer to a class of algorithms that aims to solve an optimization problem by applying a scoring function (e.g., heuristic) to select and make a “best” intermediary decisions that build upon each other and leads to a local optimal solution. The term “greedy” may imply a limited to no lookahead in making decisions and that algorithm makes decisions without an exhaustive search on all possible states. Greedy algorithms can be applied to any number of optimization problems and this disclosure contemplates any such use of a greedy algorithm.

However, it is to be appreciated that greedy algorithms generally do not guarantee a globally optimal result because these algorithms may commit to an early decision that leads to a local optimal solution. However, a greedy algorithm may return a result within a reasonable amount time. This is the trade-off for greedy algorithms, optimality is sacrificed for computational resources (e.g., time, memory, etc.).

In comparison, a quantum algorithm, such as a quantum approximation algorithm (“QAOA”), as may be executed by a quantum computer system, may seek to find the optimal solution with performance improvements over a greedy algorithm (e.g., results nearer to the optimal solution). However, current quantum algorithms may struggle to outperform classic greedy algorithms. This is because current quantum systems are noisy, and such noise may introduce errors that impact the performance of such systems. In some cases, such noise may reduce the quality of the solution for the quantum algorithm, resulting in lower performance as compared to a greedy algorithm executed by a classical computer system.

In some implementations, the systems and techniques described here can provide technical advantages and improvements. The methods and techniques presented here may improve upon greedy algorithms by incorporating results from quantum-based algorithms. A greedy algorithm that incorporates the results of quantum-based algorithms may be referred to as hybrid quantum greedy algorithms. As discussed in greater detail below, hybrid quantum greedy algorithms may, in some instances, utilize the results of quantum-based algorithms in a selection step and/or a scoring function. Such an approach may have the benefit of generating results that are potentially closer to the optimal solution. In some cases, a combination of these and potentially other advantages and improvements may be obtained.

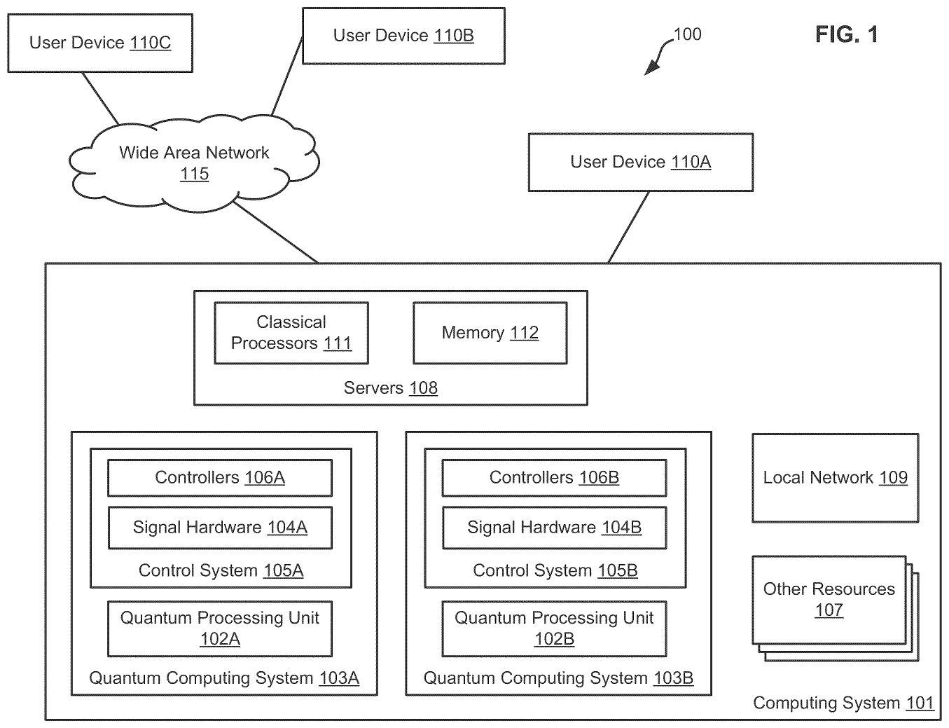

FIG. 1 is a block diagram of an example computing environment 100, according to an example embodiment. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109, and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109, or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets, or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner. For simplicity of discussion, the term “program,” as used herein, may refer to a quantum-assisted greedy algorithm, which includes a greedy algorithm that executes on a classical computer systems and a quantum-based algorithm that executes on quantum computer systems.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B, and the other resources 107 may communicate with each other through the local network 109. In some implementations, the local network 109 operates as a communication channel that provides one or more low-latency communication pathways from the server 108 to the quantum computing systems 103A, 103B (or to one or more of the elements of the quantum computing systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remote from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B, and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115, and possibly other channels. In some implementations, the servers 108 may include a host server, an application server, a virtual server, or a combination of these and other types of servers. The servers 108 may include additional or different features and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media, and memory devices, etc.

Each of the example quantum computing systems 103A, 103B operates as a quantum computing resource in the computing system 101. The other resources 107 may include additional quantum computing resources (e.g., quantum computing systems, quantum simulators, or both) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or QVM) in the computing system 101 to execute the programs, and send the programs to the identified resources for execution. For example, the servers 108 may send programs to the quantum computing system 103A, the quantum computing system 103B, or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a simulator, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv: 1608.03355v2, dated Feb. 17, 2017, or another quantum instruction language. For instance, the quantum machine instructions may be written in a format that can be executed by a broad range of quantum processing units or simulators. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may be expressed in another form or format. In some cases, a program may utilize Quil-T, described in the publication “Gain deeper control of Rigetti quantum processing units with Quil-T,” available at https://medium.com/rigetti/gain-deeper-control-of-rigetti-quantum-processors-with-quil-t-ea8945061e5b dated Dec. 10, 2020, which is hereby incorporated by reference in the present disclosure.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise); the parametric update can be performed without further compilation. In some cases, a compiler generates a full binary program that does not need to be updated or otherwise modified for execution.

In some implementations, the servers 108 generate a schedule for executing programs (such as hybrid greedy algorithms), allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing system 101 operates as a hybrid computing environment. For example, quantum programs can be formatted as hybrid classical/quantum programs that include instructions for execution by one or more quantum computing resources (e.g., the quantum-based algorithms) and instructions for execution by one or more classical resources (e.g., the greedy algorithms). The servers 108 can allocate quantum and classical computing resources in the hybrid computing environment, and delegate programs to the allocated computing resources for execution. The quantum computing resources in the hybrid environment may include, for example, one or more quantum processing units (QPUs), one or more quantum virtual machines (QVMs), one or more quantum simulators, or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors. In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in, and represented by, an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting codes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

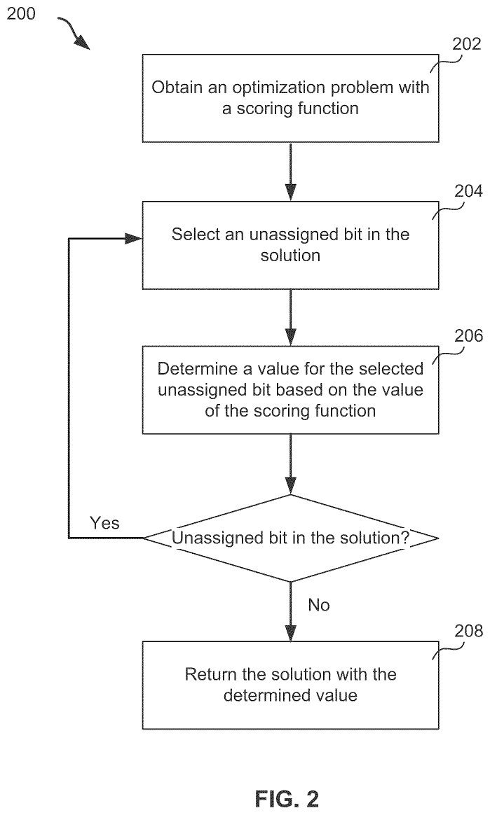

In some instances, all or part of the quantum processing unit 102A functions as a quantum processing unit, a quantum memory, or another type of subsystem. In some examples, the quantum processing unit 102A includes a superconducting quantum circuit system. The superconducting quantum circuit may include data qubit devices, stabilizer qubit devices, coupler devices, readout devices, and possibly other devices that are used to store and process quantum information. In some cases, multiple data qubit devices are operatively coupled to a single stabilizer check qubit device through respective coupler devices. In some implementations, the quantum processing unit 102A is implemented utilizing aspects designed or generated from the components and processes shown in FIGS. 2-4, or in another manner. In certain examples, the qubit devices and the coupler devices are implemented as superconducting quantum circuit devices that include Josephson junctions, for example, in Superconducting QUantum Interference Device (SQUID) loops or other arrangements, and are controlled by radio-frequency signals, microwave signals, and bias signals delivered to the quantum processing unit 102A.

In some instances, the quantum processing modules can include a superconducting quantum circuit that includes one or more quantum circuit devices. For instance, a superconducting quantum circuit may include qubit devices, readout resonator devices, Josephson junctions, or other quantum circuit devices. In some implementations, quantum circuit devices in a quantum processing unit can be collectively operated to define a single logical qubit. A logical qubit comprises a quantum register, for instance multiple physical qubits or qudits, and associated circuitry, that supports physical operations which can be used to detect or correct errors associated with logical states in a quantum algorithm. Physical operations supported by the quantum register associated with a logical qubit may include single-qubit or multi-qubit quantum logic gates and readout mechanisms. Error detection or correction mechanisms associated with a logical qubit may be based on quantum error correction schemes such as the surface code, color code, Bacon-Shor codes, low-density parity check codes (LDPC), some combination of these, or others.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems, or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computing system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations, or other types of operations. As an example, the signal hardware 104A may include arbitrary waveform generators (AWGs) that generate electromagnetic waveforms (e.g., microwave or radio-frequency) or laser systems that generate optical waveforms. The waveforms or other types of signals generated by the signal hardware 104A can be delivered to devices in the quantum processing unit 102A to operate qubit devices, readout devices, bias devices, coupler devices, or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radiofrequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers, and other types of components. In some instances, the signal delivery hardware performs preprocessing, signal conditioning, or other operations to the control signals to be delivered to the quantum processing unit 102A. In some instances, signal delivery hardware performs preprocessing, signal conditioning, or other operations on readout signals received from the quantum processing unit 102A.

The example controllers 106A communicate with the signal hardware 104A to control the operation of the quantum computing system 103A. The controllers 106A may include classical computing hardware that directly interfaces with components of the signal hardware 104A. The example controllers 106A may include classical processors, memory, clocks, digital circuitry, analog circuitry, and other types of systems or subsystems. The classical processors may include one or more single- or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in one or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bit string representing qubit state measurements for a single execution of the quantum program, and a collection of bit strings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computing system 103B and its components (e.g., the quantum processing unit 102B, the signal hardware 104B, and controllers 106B) can be implemented as described above with respect to the quantum computing system 103A; in some cases, the quantum computing system 103B and its components may be implemented or may operate in another manner.

In some implementations, the quantum computing systems 103A, 103B are disparate systems that provide distinct modalities of quantum computation. For example, the computer system 101 may include both an adiabatic quantum computing system and a gate-based quantum computer system. As another example, the computer system 101 may include a superconducting circuit-based quantum computing system and an ion trap-based quantum computer system. In such cases, the computer system 101 may utilize each quantum computing system according to the type of quantum program that is being executed, according to availability or capacity, or based on other considerations.

In some instances, one or more components of the computing system 101 shown in FIG. 1 are configured to perform the operations of the example processes 200, 300, 400, 500, 700 in FIGS. 2-5 and 7 or another process. For example, a classical computing system (e.g., the classical processors 111 in the servers 108) may execute the greedy algorithm wherein the classical processors 111 can request the quantum computing systems 103A, 103B to perform a quantum-based algorithm by executing a quantum logic circuit. Such requests and results may be communicated via a shared memory between the classical and quantum computing systems.

FIG. 2 is a flow chart showing aspects of an example process 200. In some implementations, the example process 200 is used for performing a greedy algorithm by operation of a computing system (e.g., the computing system 100 in FIG. 1). In some implementations, the example process 200 shown in FIG. 2 may operate completely on a classical computing system. The example process 200 may include additional or different operations, and the operations may be performed in the order shown or in another order. In some cases, operations in the example process 200 can be combined, iterated or otherwise repeated, or performed in another manner.

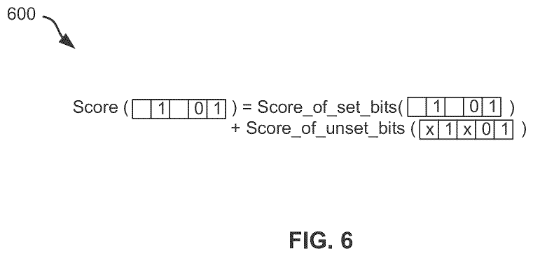

At 202, a problem to be solved using a scoring function is obtained. In some implementations, the problem is an optimization problem, including quadratic unconstrained binary optimization (QUBO) problems and may have applications in finance optimization, routing, scheduling, economics, machine learning, science, and the like. In certain instances, the scoring function may be a heuristic that quantifies the current state of the solution such that two different states can be compared against each other and measured as to which is the preferred state. In some instances, the scoring function may be implemented as the scoring function shown in FIG. 6 or in another manner.

In some instances, the solution to the problem may be represented as a bit string; and the scoring function may quantify the bit string such that the greedy algorithm attempts to find the bit string resulting in the highest value, according to the scoring function. It is to be appreciated that other implementations may represent a solution differently and may have different scoring functions.

At 204, an unassigned bit in the solution is selected. In some implementations, an unassigned bit is a bit whose value has yet to be set by operation of the computing system. In some implementations, the bit string in the solution includes multiple unassigned bits; and an unassigned bit is randomly selected from the bit string during each iteration allowing for reaching different (potentially comparatively improved) local maximums across different runs of the example process 200 for solving the same problem. In some instances, an unassigned bit can be selected in another manner from the bit string, e.g., starting from a fixed position in the bit string (e.g., beginning, end, etc.).

At 206, the value for the selected unassigned bit is determined based on the value of the scoring function. In particular, the value for the selected unassigned bit is set to a first value (e.g., ‘0’) and then uses the scoring function to evaluate the bit string with the selected unassigned bit being set to the first value (‘0’) obtaining a first score value. Then, the value of the selected unassigned bit is set to a second value (e.g., ‘1’); and a second score is obtained by evaluating the bit string with the selected unassigned bit being set to the second value (‘1’). The first and second scores are compared. The selected unassigned bit is set to the first or second value (e.g., ‘0’ or ‘1’) based on the first or second scores (e.g., the higher score for problems looking for a maximum value). For example, in response to the first score being greater than the second score, the selected unassigned bit is set to the first value (‘0’); and similarly, in response to the second score being greater than the first score, the selected unassigned bit is set to the second value (‘1’).

In some implementations, whether there is still any unassigned bit in the bit string is determined. In response to every bit in the bit string being set, the example process 200 continues with operation 208, in which the bit string is returned as the solution of the greedy algorithm to the optimization problem. In response to the bit string still including unassigned bits, the example process 200 continues with operations 204,206 where another unassigned bit in the bit string is identified and randomly selected; and the value for the selected unassigned bit is set to a value resulting in a preferred score (e.g., a highest, lowest, or any other score which results in a desired scored according to the scoring function) according to the scoring function. Operations 204, 206 are iteratively performed until all the unassigned bits in the bit string are set. In some implementations, the complexity of the problem is O(N).

After an unassigned bit is randomly selected in operation 204 and its value is set in operation 206, this bit becomes “frozen”. The greedy algorithm moves on to the next unassigned bit and operations 204, 206 are repeated till all the unassigned bits in the bit string are set (e.g., the iterative process 204, 206). In other words, during each iteration, the value of one unassigned bit is set; and the number of unassigned bits in the solution to the problem is reduced. For example, a solution to an optimization problem includes a bit string of five unassigned bits. During each iteration of operations 204, 206, a random unassigned bit is selected; and a value is set for the selected unassigned bit. The scoring function may quantify the bit string such that the algorithm attempts to find the bit string resulting in the highest value, according to the scoring function. The score for selecting 1 over 0 is based on the fact that the other bit is set to 0. In some implementations, unassigned bits in the bit string have no contributions to the score. A first unassigned bit at the second position of the bit string is set to 0; a second unassigned bit at the third position of the bit string is set to 1; a third unassigned bit at the fifth position of the bit string is set to 1; a fourth unassigned bit at the fourth position of the bit string is set to 1; and the fifth unassigned bit at the first position of the bit string is set to 0.

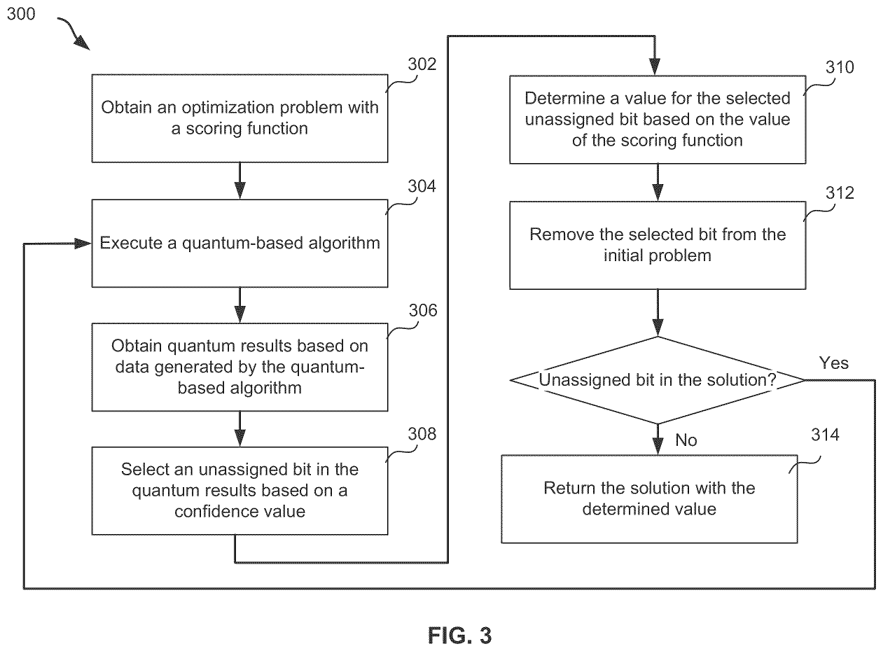

FIG. 3 is a flow chart showing aspects of an example process 300. In some implementations, the example process 300 is used for performing a greedy algorithm using quantum results by operation of a computing system (e.g., the computing system 100 in FIG. 1). The example process 300 may include additional or different operations, and the operations may be performed in the order shown or in another order. In some cases, operations in the example process 300 can be combined, iterated, or otherwise repeated, or performed in another manner.

At 302, a problem to be solved with a scoring function is obtained. In some instances, the operation 302 may be implemented as the operation 202 in FIG. 2 or in another manner.

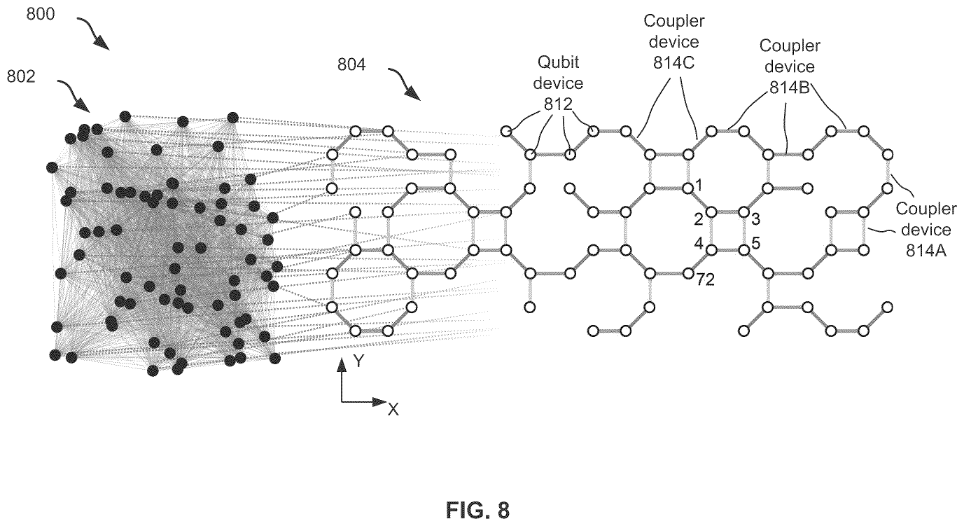

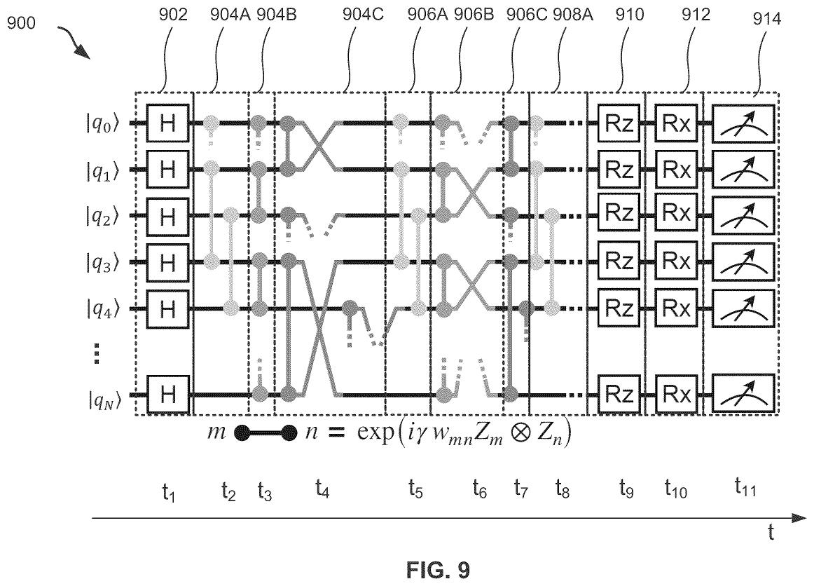

At 304, a quantum-based algorithm is executed by a quantum resource (e.g., the quantum processing unit 103A in FIG. 1) to solve the problem. In some implementations, the quantum-based algorithm is executed in a hybrid fashion between a quantum processing unit (QPU) and classical hardware (e.g., the quantum computing system 103A, the classical processor 111 of the servers 108 in the computing system 101 shown in FIG. 1). In some implementations, the classical hardware and the QPU are connected via a communication channel, e.g., a networking device, a communication bus, pins shared memory, etc. In some implementations, the quantum-based algorithm is Quantum Approximate Optimization Algorithm (QAOA), which is a type of hybrid classical/quantum machine learning algorithm (commonly used for optimization problems). In some implementations, the QAOA includes parameterized quantum logic circuits, where the parameters are selected such that the sampled output of the quantum logic circuit returns the best possible output when being executed by the QPU, with respect to the optimization problem and the scoring function. An example single-layer QAOA quantum logic circuit is shown in FIG. 9; and an example quantum processing unit with a superconducting quantum logic circuit of qubit devices for executing the single-layer QAOA quantum logic circuit is shown in FIG. 8.

In some implementations, the quantum-based algorithm is the Variational Quantum Eigensolver (VQE), which is also a class of parameterized quantum logic circuit constructions that typically include data encoding for circuit parameters that reflects symmetries in the problem domain, such as the Jordan-Wigner transformation which can encode fermionic degrees of freedom. In some implementations, the quantum-based algorithm includes parameterized quantum logic circuits that embed classical data in parameters analogous and have gates and other operations that are parameterized analogously to weights of conventional neural network layers. In some implementations, the quantum-based algorithm includes quantum kernel methods that encode data and estimate the similarity of that data to other data. The outputs of quantum-based algorithms may be measurements in the computational basis or may include measurements taken in other basis, such as random vectors on the single-qubit Bloch sphere or a random selection of a finite collection of vectors on the single-qubit Bloch sphere, or the multi-qubit equivalents, that may allow for more efficient reconstruction of certain observables.

At 306, quantum results are obtained based on data generated by the execution of the quantum-based algorithm. It is to be appreciated that when the parameters of the quantum-based algorithm are properly set, the quantum-based algorithm may return the quantum results with respect to the scoring function that is within a desirable range of the optimal results. The quantum results may, for example, include a list of solutions (e.g., a list of bit strings). On an ideal quantum computer, the quantum results may be as close to optimal as possible, but this is not practically true because of noise in the QPU where the quantum-based algorithm is executed, which impacts the correctness of the quantum results. In some instances, the quantum-based algorithm may include additional error mitigation or correction strategies to improve its output, for example virtual distillation may leverage multiple physical copies of the quantum-based algorithm during operation 304 simultaneously with controlled-SWAP or equivalent quantum logic operations between copies to improve the error rates. Another example error mitigation strategy could reduce bias in the sampled output by include twirling of individual layers or operations in the quantum logic circuit, for instance using Pauli twirling with randomized compilation for multi-qubit gates or randomizing the readout basis. In some instances, bit strings can be generated by an adiabatic quantum algorithm, a quantum annealer, or in another manner. In some instances, the bit strings may be generated by any classical means (e.g., Monte Carlo, genetic algorithm).

At 308, an unassigned bit that is derived from the list of solutions obtained during operation 306 is selected based on an objective function. In some implementations, the unassigned bit is selected by a classical computing system (e.g., the classical processor 111 in FIG. 1). When an unassigned bit from the bit string is selected to set, the size of the initial optimization problem obtained during operation 302 is reduced by one bit and a new reduced optimization problem involving the unassigned bits is identified.

In some implementations, the objective function used to select an unassigned bit is a scoring function, e.g., a confidence function for determining a confidence value. In certain instances, other objective functions may be used to select an unassigned bit from the quantum results. In some implementations, before selecting an unassigned bit in the output, identifying a plurality of unassigned bit of the output, respective confidence values for the plurality of unassigned bits are determined; and the unassigned bit can be selected based on the confidence values. In some instances, this selection of an unassigned bit performed during operation 308 can be thought of as a majority vote, but some implementations of the example process 300 operate more subtly. One reason is that for most problems, if one is given a bit string and performs the transformation 0<->1 on all bits, then the new bit string obtained will be a comparable solution. In other words, a system cannot do a simple majority vote to make the decision because in the list of solutions obtained during operation 306, the system will have for a given bit (a given column in the list of solutions) as many 0 as 1, on average. Thus, there may not be a majority in this situation. Even if there is one, there might be a better decision process based on global information (e.g., by considering the value of the other bits in addition to the value of the selected bit). For instance, the system may loop over all bits. For each of them, the system may determine how strongly correlated the selected bit is with the other bits. The system then selects the bit which is the most correlated. In other words, the classical computing system can select the bit which has the strongest affinity with the others. In some implementations, this is a highly parallelizable operation and possible implementations include dedicated compute resources, for instance cores of classical CPU, asynchronous software processes, or dedicated transistor level logic (e.g., FPGA) to filtering data and estimating a solution during operations 306, 308, 310.

In response to determining that there are no preferred bits to select based on the confidence value, an unassigned bit may be selected randomly, and the process 300 recovers the behavior of the classical greedy algorithm (e.g., example process 200 of FIG. 2). It is to be appreciated that operation 308 has been discussed as selecting one bit but it is to be appreciated that other implementations may select any number of bits depending on the implementation, say 2, 3, 4 and so on. For clarity of description, the term selected bit may refer to one or more bits selected during operation 308.

At 310, a value of the selected unassigned bit leading to the highest score value according to the scoring function is determined. In some implementations, the list of bit strings from the quantum-based algorithm is used during operation 310. The idea is that to test 0 or 1, a column in the list of quantum results corresponding to the unassigned bit that was selected is modified temporality. For example, every bit in that column is set to 0, and then 1. For each of the two cases, the list of updated bit strings is fed to the scoring function. The value of the unassigned bit is, e.g., 0 or 1, is determined based on the score value. So there is a greedy component, which is trying 0 or 1, but the system utilizes a “quantum part” because the list of bit strings from the quantum-based algorithm is used. In some implementations, the bits which were not selected for freezing (e.g., unassigned bits) can still contribute to the score value. It is to be appreciated that in a purely classical greedy approach, these bits do not exist yet (since the solution is constructed bottom to top) and so they do not contribute to the score at all.

At 312, after determining the value for the selected unassigned bit, the bit is removed from the problem; and a number of unassigned bits in the quantum results is reduced. In some implementations, removing the bit with the determined value, a new problem, which depends on the selected bit and what value it was set to, is generated. This newly generated problem is smaller by one bit/qubit compared to the initial optimization problem during each iteration. In some implementations, whether there is still any unassigned bit in the bit string is determined. In response to every bit in the bit string being set, the example process 300 continues with operation 314, in which the bit string is returned as the solution of the greedy algorithm to the optimization problem. In response to the bit string still including unassigned bits, the example process 300 continues with operations 304, 306, 308, 310, 312. With this new problem, involving unassigned bits, the example process 300 continues with operations 304, 306, 308, 310, 312, in which a list of quantum results (e.g., bit strings) with “one less column” since that bit has been removed from the problem. In some implementations, the complexity of the problem is O(N), where N is the number of bits in a solution. In some instances, once the problem size at operation 312 is a sufficiently small size, multiple samples may be drawn from the QPU concurrently by mapping the optimization problem redundantly onto distinct regions of the quantum processing unit, which may accelerate parameter setting and sampling of the quantum-based algorithm. As an example, once the problem has set half of the overall problem bits, two copies of the quantum-based algorithm may be compatible with concurrent operations of distinct sections of the QPU.

At 314, when every bit is set, the resulting bit string based on the bits is returned as the solution to the initial optimization problem. In some instances, other stopping conditions may be met, for instance convergence to a fixed solution quality, or a total number of calls (e.g., time) to solution is reached, or a final problem size is reached for instance a small size where brute-force search is efficient.

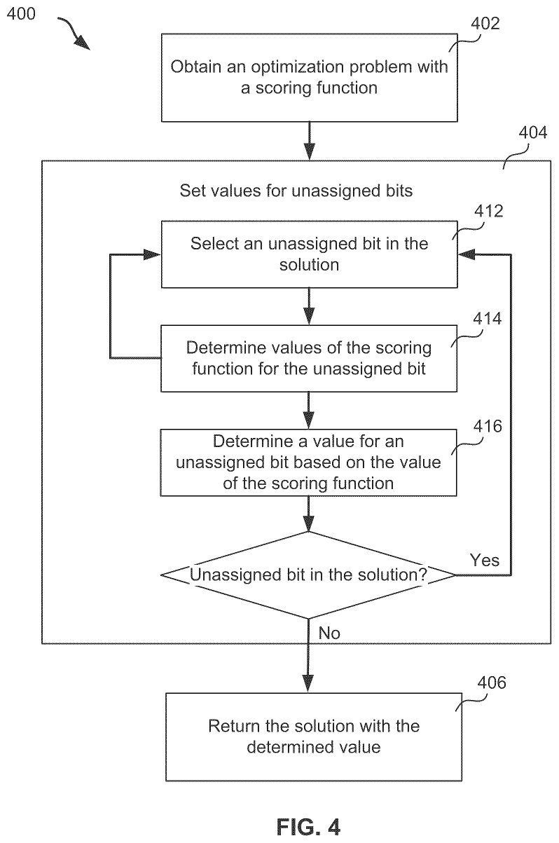

FIG. 4 is a flow chart showing aspects of an example process 400. In some implementations, the example process 400 is used for performing a greedy algorithm by operation of a computing system (e.g., the computing system 100 in FIG. 1). It is to be appreciated that the example process 400 shown in FIG. 4 may operate completely on a classical computing system. The example process 400 may include additional or different operations, and the operations may be performed in the order shown or in another order. In some cases, operations in the example process 400 can be combined, iterated or otherwise repeated, or performed in another manner.

At 402, a problem to be solved using a scoring function is obtained. The operations 402 may be implemented as the operations 202 in the example process 400 in FIG. 2 or in another manner.

At 404, values of unassigned bits are set. The greedy algorithm attempts every single unassigned bit in the bit strings. For each of them, it tries 0 and 1 and it keeps track of the resulting score. In the end, one unassigned bit will be set at a value leading to the best score. As shown in FIG. 4, the operation 404 includes two loops of iterative processes. A first loop of iterative processes includes suboperation 412 in which an unassigned bit in the solution is selected; and suboperation 414 in which values of the scoring function for the unassigned bit being set at different values (‘0’ and ‘1’) are determined. Once the values of the scoring function for the selected unassigned bit being set at different values are determined, the scores are stored. The first loop of iterative processes 412, 414, 416 is repeated for a second unassigned bit to determine the values of the scoring functions for the second unassigned bit being set at different values. A first loop of iterative processes is terminated until all the unassigned bits are evaluated and all the values of the scoring functions are determined. The operation 404 continues with sub-operation 416 in a second loop of iterative processes, during which all the values of the scoring functions associated with all the unassigned bits being set at all different values are compared. One unassigned bit and its value resulting in the highest value of the scoring function are determined. In this case, a first unassigned bit is set; and the value of the first unassigned bit is frozen after the first iterative process.

The operation 404 continues with the first loop of iterative processes by determining the values of the scoring function for all unassigned bits left and being set at different values (‘0’ and ‘1’); and continues with the sub-operation 416 in the second loop of iterative processes to determine a second unassigned bit and its value resulting in the highest value of the scoring function. The second loop of iterative processes continues once values of all the unassigned bits are set. In some implementations, the complexity of the problem is O(N²).

For example, a solution to an optimization problem includes a bit string of five unassigned bits. One unassigned bit is selected from the five unassigned bits; and respective scores with that unassigned bit being set at respective values (‘0’ or ‘1’) are determined. After all the five unassigned bits are evaluated, ten scores associated with all five unassigned bits being set at two different values ‘0’ or ‘1’ are compared. For example, in response to the highest score being obtained when the second unassigned bit being set as ‘0’, the value of the second unassigned bit is frozen to ‘0’. The solution now includes four unassigned bits left. One unassigned bit is selected from the four unassigned bits; and respective scores with that unassigned bit being set at respective values (‘0’ or ‘1’) are determined. After all the four unassigned bits are evaluated, eight scores associated with the four unassigned bits being set at two different values ‘0’ or ‘1’ are compared. For example, in response to the highest score being obtained when the third unassigned bit being set as ‘1’, the value of the third unassigned bit is frozen to ‘1’. The solution now includes three unassigned bits; and the iterative process continues once values for the unassigned bits are set.

In some implementations, whether there is still any unassigned bit in the bit string is determined. In response to every bit in the bit string being set, the example process 400 continues with operation 406, in which the bit string is returned as the solution of the greedy algorithm to the optimization problem. In response to the bit string still including unassigned bits, the example process 400 continues with operations 412, 414, 416. At 406, the bit string is returned as the solution of the greedy algorithm to the optimization problem. In some implementations, the operation 406 may be implemented as operation 208 of the example process 200 in FIG. 2 or in another manner.

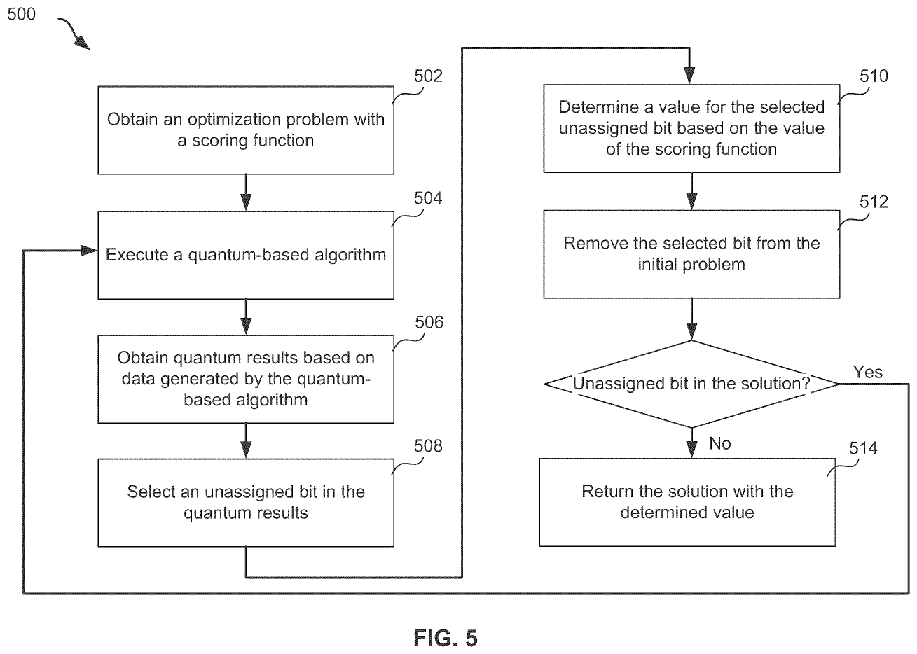

FIG. 5 is a flow chart showing aspects of an example process 500. In some implementations, the example process 500 is used for performing a greedy algorithm using quantum results by operation of a computing system (e.g., the computing system 100 in FIG. 1). The example process 500 may include additional or different operations, and the operations may be performed in the order shown or in another order. In some cases, operations in the example process 500 can be combined, iterated or otherwise repeated, or performed in another manner.

At 502, a problem to be solved with a scoring function is obtained; at 504, a quantum-based algorithm is executed by a quantum resource (e.g., the quantum processing unit 103A in FIG. 1) to solve the problem; and at 506, quantum results are obtained based on data generated by the execution of the quantum-based algorithm. In some implementations, operations 502, 504, 506 in the example process 500 may be implemented as the operations 302, 304, 306 of the example process 300 shown in FIG. 3 or in another manner.

At 508, an unassigned bit is selected. In some instances, an unassigned bit can be selected randomly or in another manner. In certainly instances, an unassigned bit may be selected according to a function, e.g., a confidence value or another function.

At 510, a value of the selected unassigned bit leading to the highest score value according to the scoring function is determined. Every unassigned bit is looped over; and different values, e.g., ‘0’ or ‘1’, are tried; the best score value is determined and stored. The operation 510 guarantees that the decision taken will give a classical greedy baseline to the algorithm.

At 512, after determining the value for the selected unassigned bit, the bit is removed from the problem; and a number of unassigned bits in the quantum results is reduced. In some implementations, removing the bit with the determined value, a new problem, which depends on the selected bit and what value it was set to, is generated. This newly generated problem is smaller by one bit/qubit compared to the initial optimization problem during each iteration. In some implementations, whether there is still any unassigned bit in the bit string is determined. In response to every bit in the bit string being set, the example process 500 continues with operation 514, in which the bit string is returned as the solution of the greedy algorithm to the optimization problem. In response to the bit string still including unassigned bits, the example process 500 continues with operations 504, 506, 508, 510, 512. With this new problem, involving unassigned bits, the example process 500 continues with operations 504, 506, 508, 510, 512, in which a list of quantum results (e.g., bit strings) with “one less column” since that bit has been removed from the problem. In some implementations, the complexity of the problem is O(N).

At 514, when every bit is set, the resulting bit string based on the bits is returned as the solution to the initial optimization problem. In some implementations, operations 510, 512, 514 in the example process 500 may be implemented as the operations 310, 312, 314 of the example process 300 shown in FIG. 3 or in another manner.

As shown in FIG. 5, the example process 500 includes both a greedy component, which is trying ‘0’ or ‘1,’ and a “quantum part” because the operation 510 uses the list of solutions from QAOA and the unassigned bits which were not set to 0/1 can still contribute to the scoring. In a purely classical greedy approach (e.g., the example process 200, 400 shown in FIGS. 2 and 4), these bits do not exist yet (since the solution is constructed bottom to top) and, as a result, the unassigned values do not contribute to the scoring function at all.

FIG. 6 is a schematic diagram showing a scoring function 600. In some instances, the scoring function 600 may be used in the example processes 200, 300, 400, 500, 700 in FIGS. 2-5, 7, or in another process when a greedy algorithm is executed for solving an optimization problem. As shown in FIG. 6, a score of a bit string based on the scoring function 600 includes a summation of a first component and a second component. In particular, the first component corresponds to a contribution of assigned (e.g., set or frozen) bits; and the second component corresponds to a contribution of unassigned (e.g., unset or unfrozen) bits. In some implementations, the first component is obtained from the freezing decisions at a previous iteration of the algorithm; and the second component depends on the list of solutions (bit strings) from the operations 306, 506 in the example processes 300, 500 in FIGS. 3 and 5. In some instances, the value of the second component equals zero for the classical greedy version of the algorithm in the example processes 200, 400 in FIGS. 2 and 4. An example of what the scoring function may be in mathematical terms, in the form of an Ising model, can be expressed as:

$$Score = {Σ}_{( i , j ) ϵSet} {w}_{ij} {S}_{i} {S}_{j} + {Σ}_{( i , j ) ϵUnset} {w}_{ij} 〈 {Z}_{i} {Z}_{j} 〉 + {Σ}_{iϵSet} {S}_{i} ( {Σ}_{jϵUnset} {w}_{ij} 〈 {Z}_{j} 〉 ) \qquad ( 1 )$$

where Sᵢ, Sⱼ are the expectation values of the frozen variables i and j such that Sᵢ=(−1)^{B}^{ᵢ} with Bᵢ∈[0,1] depending on the frozen value of the bit i (Sᵢ,Sⱼ equal ±1); Zᵢ, Zⱼ are the Pauli operators on variables i and j, wᵢⱼ is a scalar parameter. For random bit strings, all [symbol] . [symbol] average to zero. As shown in equation (1), the scoring function includes two-body terms. In some instances, the scoring function may include single-body terms or multi-body terms.

In some instances, the scoring function may be based on two-body expectation values or in another manner. In some implementations, an unassigned bit to freeze is selected based on a confidence value, e.g., during the operations 308 in the example process 300 in FIG. 3. In some implementations, the confidence value can be determined based on a confidence function. In some instances, a confidence function can be expressed as

$$Confidence ( i ) = {\sum }_{j ∈ Set} \vert {w}_{ij} {S}_{j} 〈 {Z}_{i} 〉 \vert + {\sum }_{j \neq i ∈ Unset} \vert {w}_{ij} 〈 {Z}_{i} {Z}_{j} 〉 \vert \qquad [ 2 ]$$

where Sⱼ equal ±1. For random bit strings, all [symbol] . [symbol] equal zero. In some instances, the confidence function may be in another form. In some instances, the confidence function can be expressed as

$$Confidence ( i ) = {\sum }_{j ∈ Set} \vert {w}_{ij} {S}_{j} \times ( \pm 1 ) \vert + {\sum }_{j \neq i ∈ Unset} \vert {w}_{ij} 〈 {Z}_{j} 〉 \times ( \pm 1 ) \vert \qquad [ 3 ]$$

±1 is tried and the one resulting in a greatest confidence value in the confidence function is kept as the confidence for bit i.

It is to be appreciated that implementations may have a number of practical advantages. For example, if the execution of the quantum-based algorithm, e.g., during the operations 304 and 504 in the example process 300, 500 in FIGS. 3 and 5 returns an optimal solution, then the methods and techniques presented here may conserve this solution even as it operates the greedy algorithm steps (e.g., choosing between ‘1’ or ‘0’ based on the quantum results from the execution of the quantum-based algorithm). Hence, there may not be a restriction on the upper bound for the performances in that the optimal solution can be the result. With regards to the lower bound, in the quantum-boosted greedy algorithms, if the execution of the quantum-based algorithm returns a random list of solutions, then the quantum-based algorithm will perform like the classical greedy algorithm. This puts a lower bound (assuming the worst case is the quantum computer returning random bit strings) on the performances.

Further, the quantum-based algorithm (e.g., QAOA) can be seen as a black box returning a result (e.g., bit strings). Here, it is a quantum-based algorithm, but this disclosure contemplates that other implementations may utilize other types of algorithms, such as a Monte Carlo algorithm, a simulated annealer, a quantum annealer, or any other suitable algorithm.

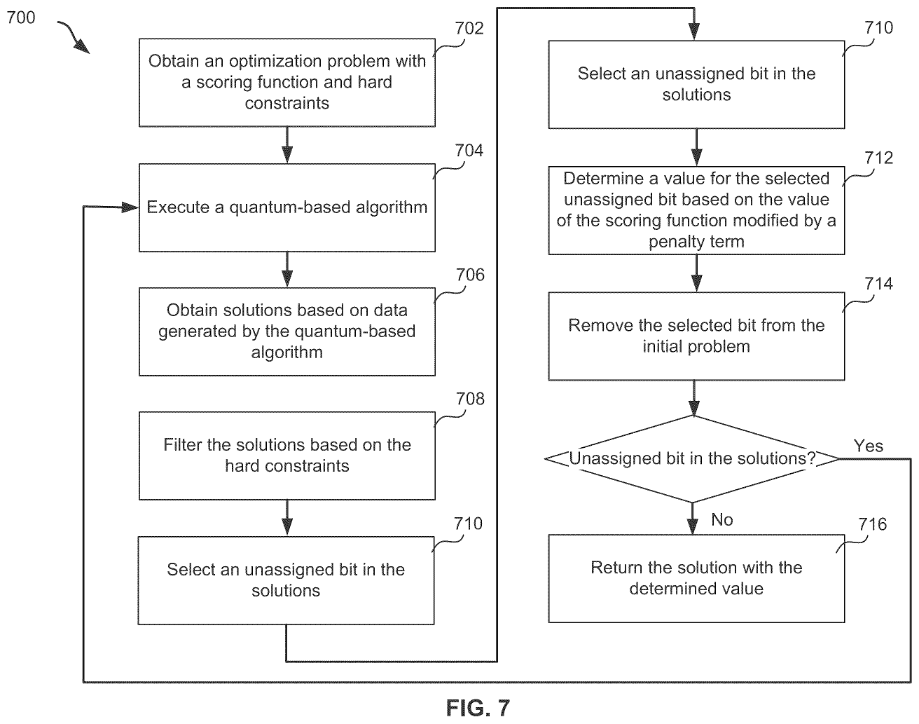

FIG. 7 is a flow chart showing aspects of an example process 700. In some implementations, the example process 700 is used for performing a greedy algorithm using quantum results by operation of a computing system (e.g., the computing system 100 in FIG. 1) using a classical-quantum hybrid approach. The example process 700 may include additional or different operations, and the operations may be performed in the order shown or in another order. In some cases, operations in the example process 700 can be combined, iterated or otherwise repeated, or performed in another manner.

The methods and techniques presented here can be used for solving binary optimization problems with hard constraints, can ensure that the hard constraints are fulfilled by construction and the final candidate solution necessarily valid, e.g., within the hard constraints, even if the intermediate input bit strings do not. The methods and techniques presented here guarantee an average minimum quality for the final candidate solution to the binary optimization problem of interest. The methods and techniques presented here allow the use of error mitigation techniques which are based on the expectation value of observables along with the QAOA algorithm. The methods and techniques presented here may be used in other contexts than a programmable quantum computer. For example, the list of bit strings taken as an input can be generated by other means than the QAOA algorithm.

At 702, a problem to be solved with a scoring function and hard constraints is obtained. In some implementations, the problem is an optimization problem, including quadratic unconstrained binary optimization (QUBO) problems and may have applications in finance optimization, routing, scheduling, economics, machine learning, science, and the like. In certain instances, the scoring function may be a heuristic that quantifies the current state of the solution such that two different states can be compared against each other and measured as to which is the preferred state. In some instances, the scoring function may be implemented as the scoring function shown in FIG. 6 or in another manner.

In some implementations, the optimization problem includes hard constraints. A hard constraint is such that if a bit string does not fulfill it, it is an invalid candidate solution to the problem. An example of such a constraint is the total number of ‘1’ in the bit string which should be strictly equal to a given integer value for the bit string to be valid. In some instances, the hard constraints may include constraints that are equalities and/or inequalities. The hard constraints in the optimization problem include constraints for which the feasibility decision is easily solved classically.

At 704, a quantum-based algorithm is executed by a quantum resource (e.g., the quantum processing unit 103A in FIG. 1) to solve the problem. In some implementations, a quantum circuit for the QAOA algorithm that can automatically fulfill the hard constraints is constructed. In some implementations, the quantum-based algorithm is executed in a hybrid fashion between a quantum processing unit (QPU) and classical hardware (e.g., the quantum computing system 103A, the classical processor 111 of the servers 108 in the computing system 101 shown in FIG. 1). In some implementations, the classical hardware and the QPU are connected via a communication channel, e.g., a networking device, a communication bus, pins shared memory, etc. In some implementations, the quantum-based algorithm is Quantum Approximate Optimization Algorithm (QAOA), which is a type of hybrid classical/quantum machine learning algorithm (commonly used for optimization problems). In some implementations, the QAOA includes parameterized quantum logic circuits, where the parameters are selected such that the sampled output of the quantum logic circuit returns the best possible output when being executed by the QPU, with respect to the optimization problem and the scoring function. An example single-layer QAOA quantum logic circuit is shown in FIG. 9; and an example quantum processing unit with a superconducting quantum logic circuit of qubit devices for executing the single-layer QAOA quantum logic circuit is shown in FIG. 8.

In some implementations, the quantum-based algorithm is the Variational Quantum Eigensolver (VQE), which is also a class of parameterized quantum logic circuit constructions that typically include data encoding for circuit parameters that reflects symmetries in the problem domain, such as the Jordan-Wigner transformation which can encode fermionic degrees of freedom. In some implementations, the quantum-based algorithm includes parameterized quantum logic circuits that embed classical data in parameters analogous and have gates and other operations that are parameterized analogously to weights of conventional neural network layers. In some implementations, the quantum-based algorithm includes quantum kernel methods that encode data and estimate the similarity of that data to other data. The outputs of quantum-based algorithms may be measurements in the computational basis or may include measurements taken in other basis, such as random vectors on the single-qubit Bloch sphere or a random selection of a finite collection of vectors on the single-qubit Bloch sphere, or the multi-qubit equivalents, that may allow for more efficient reconstruction of certain observables.

In some instances, for example when it is not possible to construct a quantum logic circuit that can automatically fulfill the constraints, operation 708 can be implemented.

At 706, quantum results are obtained based on data generated by the execution of the quantum-based algorithm. It is to be appreciated that when the parameters of the quantum-based algorithm are properly set, the quantum-based algorithm may return the quantum results with respect to the scoring function that is within a desirable range of the optimal results. The quantum results may, for example, include a list of solutions (e.g., a list of bit strings). On an ideal quantum computer, the quantum results may be as close to optimal as possible, but this is not practically true because of noise in the QPU where the quantum-based algorithm is executed, which impacts the correctness of the quantum results. In some instances, the quantum-based algorithm may include additional error mitigation or correction strategies to improve its output, for example virtual distillation may leverage multiple physical copies of the quantum-based algorithm during operation 304 simultaneously with controlled-SWAP or equivalent quantum logic operations between copies to improve the error rates. Another example error mitigation strategy could reduce bias in the sampled output by include twirling of individual layers or operations in the quantum logic circuit, for instance using Pauli twirling with randomized compilation for multi-qubit gates or randomizing the readout basis. In some instances, bit strings can be generated by an adiabatic quantum algorithm, a quantum annealer, or in another manner. In some instances, the bit strings may be generated by any classical means (e.g., Monte Carlo, genetic algorithm).

At 708, out-of-constraint bit strings are further filtered out. After obtaining initial quantum results indicative of a plurality of solutions to the optimization problem as determined by the quantum-based algorithm; the one or more solutions are selected from the plurality of solutions based on a hard constraint for the optimization problem. For example, when the quantum logic circuit for the QAOA algorithm that can automatically fulfill the hard constraints is not constructed and not all of the out-of-constraint bit strings can be completely filtered by the QAOA algorithm, out-of-constraint bit strings in the quantum results can be filtered out by looping over them using a classical computing system. This may require that there are in-constraint bit strings in the output in the list of solutions with a number of the in-constraint bit strings greater or equal to a predetermined threshold value. In some implementations, the in-constraint bit strings are a finite fraction of the list of solutions; and the threshold value is equal to or greater than 1. In some instances, the operation 708 may be omitted from the example process 700, when the quantum logic circuit for the QAOA algorithm that can automatically fulfill the hard constraints is constructed during operation 704.

At 710, an unassigned bit is selected from the list of solutions. In some implementations, the operation 710 may be implemented as the operation 308, 508 in FIGS. 3, 5 or in another manner.

At 712, a value of the selected unassigned bit leading to the highest score value according to the scoring function is determined. In some implementations, the list of bit strings from the quantum-based algorithm after out of constraint bit strings are filtered out is used during operation 712. The idea is that to test 0 or 1, a column in the list of quantum results corresponding to the unassigned bit that was selected is modified temporarily. For example, every bit in that column is temporarily set to one of the binary values, e.g., 0 and then 1. For each of the two cases, the list of updated bit strings is fed to the scoring function. The value of the unassigned bit is, e.g., ‘0’ or ‘1’, is determined based on the score value. So there is a greedy component, which is trying 0 or 1, but the system utilizes a “quantum part” because the list of bit strings from the quantum-based algorithm is used. In some implementations, the bits which were not selected for freezing (e.g., unassigned bits) can still contribute to the score value. It is to be appreciated that in a purely classical greedy approach, these bits do not exist yet (since the solution is constructed bottom to top) and so they do not contribute to the score at all.

In some implementations, penalty terms can be added to the scoring function. For example, penalty terms on in-constraint bit strings give a zero contribution to the value of the scoring function, while the penalty terms result in finite values for out-of-constraint bit strings. If the goal is to minimize the scoring function, the penalty term on the out-of-constraint bit strings would be positive and the value of the corresponding scoring function would be effectively greater than the value of the scoring function corresponding to the in-constraint bit strings. If the goal is to maximize the scoring function, the penalty term on the out-of-constraint bit strings would be negative and the value of the corresponding scoring function would be effectively less than the value of the scoring function corresponding to the in-constraint bit strings. In some instances, a penalty term in the scoring function may be tunable and can be predetermined. The strength of the penalty term to the value of the scoring function can be tuned.

In some implementations, a first value for the selected unassigned bit is determined by the classical computing system; and if the determined first value bring the solution out of the hard constraint space, the first value can be rejected based on a hard constraint for the optimization problem. After rejecting the first value, a second, opposite value for the selected unassigned bit can be selected. For example, if the decision of setting the frozen value to ‘0’ or ‘1’ brings the solution out of the hard constraint space, the other option (0→1 or 1→0) can be selected, even making that decision reduces the score value. In some implementations, ensuring that the bit string with determined values meets the hard constraints, e.g., in-constraint bit strings is important in order to make sure iteratively constructed solutions are within the space of in-constraint solutions.

In some instances, during operation 712, a different bit for which one is the surest of its value can be selected. From there, one would do the “set” step as described in operation 510 of the example process 500 above with the selected different bit. One could move to the ‘next next’ bit, and so on, until a final decision is made. Here, there is a tradeoff between (i) selecting a good bit and (ii) being able to set it to a value leading to the best score (e.g., maximum score value) while fulfilling the hard constraints. In some instances, the “greedy baseline” can be removed altogether by choosing arbitrary “set” and “select” strategies, which do not guarantee minimum performance but would still ensure that the hard constraints are fulfilled.

In some implementations, whether there is still any unassigned bit in the bit string is determined. In response to every bit in the bit string being set, the example process 700 continues with operation 716, in which the bit string is returned as the solution of the greedy algorithm to the optimization problem. In response to the bit string still including unassigned bits, the example process 700 continues with operations 704, 706, 708, 710, 712, 714. In some implementations, operations 702, 704, 706, 710, 714, 716 in the example process 700 may be implemented as the operations 502, 504, 506, 508, 512, 514, of the example process 500 shown in FIG. 5 or in another manner.

As an example, the iterative process with each iteration shown in the example process of FIG. 5 is implemented on Sherrington-Kirkpatrick (SK) problem instances with different sizes N (N=8, 24, 40, 56 and 72). Parameters used in defining the SK problems can be found in Appendix A. A truncated single-layer QAOA is used as the quantum-based algorithm during operation 504. Each of the SK problem instances is randomly mapped to qubit devices in a superconducting quantum processing unit.

FIG. 8 is a schematic diagram 800 showing aspects of an example binary optimization problem 802 mapped onto qubit devices in a quantum processing unit 804. The example binary optimization problem 802 is represented by a graph with nodes encoding N=72 variables and edges encoding interactions between nodes. As shown in FIG. 8, the example quantum processing unit 804 includes a superconducting quantum circuit, which includes qubit devices 812, coupler devices 814A, 814B, 814C, and other quantum circuit devices. As shown in FIG. 8, a qubit device 812 is coupled to at least one neighboring qubit device 812 through a respective coupler device 814A, 814B, 814C. Generally, a quantum processing unit may include any number of qubit devices in any geometric configuration or spatial arrangement. In certain implementations, the quantum processing unit 804 may include additional or different components, and the components may be arranged as shown or in another manner.

In some implementations, qubit devices 812 are implemented as a tunable-frequency qubit devices, e.g., tunable-frequency transmon qubit devices, tunable-frequency flux qubit devices, tunable-frequency flatsonium qubit devices, tunable-frequency fluxonium qubit devices, or other types of tunable-frequency qubit devices. In some instances, a qubit device may be implemented as a fixed-frequency qubit device. In some implementations, each of the coupler devices 814 is a tunable-frequency coupler device which can be controlled to allow electromagnetic coupling or decoupling between the neighboring qubit devices 812. For example, tunable-coupler devices may be deactivated to segment qubit devices into QPU sublattices. In some implementations, a topology of QPU lattices in a quantum processing unit can be tuned, updated or otherwise changed by activating or disactivating the tunable-frequency coupler devices. In some instances, the coupler devices 814 may include one or more coupler elements providing a fixed coupling between two neighboring qubit devices 812.

In the example quantum processing unit 804 shown in FIG. 8, each of the qubit devices 812 can define a single bit of quantum information. Each of the qubit devices 812 has two eigenstates that are used as computational basis states, and each qubit device can transition between its computational basis states or exist in an arbitrary superposition of its computational basis states. In some examples, the two lowest energy levels (e.g., the ground state |0 [symbol] and the first excited state |1 [symbol] of each qubit device are defined as a qubit and used as computational basis states for quantum computation. In some examples, higher energy levels (e.g., a second excited state |2 [symbol] or a third excited state |3 [symbol] ) are also defined by a qubit device and may be used for quantum computation in some instances.

Qubits defined by respective qubit devices can be manipulated by control signals, or read by readout signals, generated by a control system (e.g., the control system 105). The qubit devices can be controlled individually, for example, by delivering control signals to the respective qubit devices. In some cases, the quantum processing unit 804 includes readout devices that can detect the qubits of the qubit devices 812, for example, by interacting directly with the respective qubit devices 812.

In some examples, a qubit device 812, when implemented as a tunable-frequency qubit device which has a transition frequency that can be tuned, includes a quantum circuit loop (e.g., a SQUID loop). The quantum circuit loop receives a magnetic flux that tunes the transition frequency of the tunable-frequency qubit device. In some instances, the transition frequency can be tuned within a range of qubit operating frequencies. The quantum circuit loop may include two Josephson junctions, and the tunable-frequency qubit device may also include a shunt capacitor connected in parallel with each of the two Josephson junctions. In some examples, a transition frequency, which defines a qubit operating frequency of a tunable-frequency qubit device, is tunable, for example, by application of a magnetic flux. A qubit operating frequency of the tunable-frequency qubit device may be defined at least in part by Josephson energies of the two Josephson junctions, a capacitance of the shunt capacitor, and a magnetic flux threading the quantum circuit loop.

In some implementations, a coupler device 814A, 814B, 814C, when implemented as a tunable-frequency coupler device, may receive control signals to enable electromagnetic coupling or decoupling between the qubit devices 812. When two or more qubit devices are coupled, the two or more qubit devices can be used to perform multi-qubit quantum logic gates (e.g., perform quantum logic gates or operations proscribed by a quantum circuit).

In some implementations, the quantum processing unit 804 is a modular quantum processing unit. In some implementations, a modular quantum processing unit includes a two-dimensional or three-dimensional array of quantum processor modules that are interconnected to each other. Each of the quantum processor modules in a modular quantum processing unit may include a superconducting quantum integrated circuit (QuIC). The superconducting QuIC can include quantum circuit devices, for example, qubit devices (e.g., transmon devices, fluxonium devices, or other types of superconducting qubit devices), coupler devices (e.g., capacitive coupler device, tunable-frequency coupler device, or others), readout devices, or other types of quantum circuit devices that are used for quantum information processing in the modular quantum processing unit. The superconducting QuIC of each of the quantum processor modules may include one or more Josephson junctions, capacitors, inductors, and other types of circuit elements. Each of the quantum processor modules may include a two-dimensional or three-dimensional array of quantum circuit devices. In some instances, the modular quantum processing unit and each of the quantum processor modules may be implemented in another manner.

In some cases, neighboring quantum processor modules in a modular quantum processing unit are interconnected by superconducting circuitry which includes inter-chip coupler devices. For example, as shown in FIG. 8, two neighboring qubit devices 812 may reside on two separate quantum processor modules and the coupler devices 814 can be implemented as inter-chip coupler devices that enable coupling of qubit devices in distinct quantum processor modules. In some implementations, inter-chip coupler devices are tunable. In some instances, coupling between two neighboring quantum processor modules may be activated or deactivated by communicating control signals to the inter-chip coupler devices, for example, when segmenting qubit devices from quantum processor modules to form QPU sublattices for performing operations in the example process 300, 500, 700 in FIGS. 3, 5, 7 or another process.

In some implementations, the quantum computing system includes multiple quantum processing units 804 that are separately enclosed in distinct thermal environments (e.g., dilution refrigerator systems). For instance, each QPU may be housed in a separate dilution refrigerator that includes multiple thermal stages that create a very low temperature environment (e.g., T<120 K) for the QPU. As shown in FIG. 8, two or more of the qubit devices 812 may reside on two quantum processing unit 804 in two separate dilution refrigerator systems. In this case, coupler devices 814A, 814B, 814C represent systems and interconnections between two quantum processing units 804 in two separate dilution refrigerator systems. For example, the coupler device 814A, 814B, 814C includes an optical link which can carry signals in the optical regime to control qubit devices, drive qubit devices, and generate entanglement between qubit devices in separated dilution refrigerator systems. In this case, the coupler device 814A, 814B, 814C includes optical components (e.g., optical fibers) and signal conversion/delivery units. In some instances, the coupler device 204 includes a superconducting link which can carry signals in the RF or microwave regime to control qubit devices, drive qubit devices, and generate entanglement between qubit devices in separated dilution refrigerator systems. In this case, the coupler device 814A, 814B, 814C includes superconducting circuit components (e.g., superconducting cabling) and signal delivery units. In some implementations, the coupler devices 814A, 814B, 814C can be controlled to activate or deactivate coupling between qubit devices in separate dilution refrigerator systems, for example, for performing the quantum-based algorithm during operations 304, 504, 704 in the example process 300, 500, 700 in FIGS. 3, 5, 7, the single-layer QAOA quantum logic circuit 900 in FIG. 9, or in another process. As shown in FIG. 8, the coupler devices are divided into three independent set: a first set of coupler devices 814A (along the vertical y-axis direction), a second set of coupler devices 814B (along the horizontal x-axis direction), and a third set of coupler devices 814C (along a direction offset from the y- and x-axis), such that two-qubit quantum logic gates can be executed in parallel.

FIG. 9 is a block diagram showing aspects of an example quantum logic circuit 900. In some implementations, the example quantum logic circuit 900 represents part of the quantum approximation optimization algorithm or a quantum alternative operator Ansatz (QAOA), a truncated single-layer QAOA, or another type of quantum program. The example quantum logic circuit 900 includes unitary operations applied to qubits defined qubit devices of a quantum processing unit. In some implementations, the quantum logic circuit 900 represents part of a native quantum program with native quantum logic gates. In some instances, the example quantum logic circuit 900 includes unitary operations which may be generated by operation of a compiler in a server (e.g., the server 108 of the computing system 101 of FIG. 1) based on a quantum program (e.g., a user program) or may be received from a user device (e.g., the user device 110 of FIG. 1). In some implementations, the example quantum logic circuit 900 may be performed on a superconducting quantum processing unit (e.g., the example superconducting quantum processing unit 103A, 804 in FIGS. 1, 8) or other superconducting quantum processing unit or other quantum processor modalities.

As shown in FIG. 9, the example quantum logic circuit 900 includes a set of transversal Hadamard gates applied to qubits defined by qubit devices (e.g., q₀, q₁, . . . q_{N}) at a first time step t₁. A Hadamard gate 902 is configured to generate a target coherent superposition state on each of the qubit devices. The example quantum logic circuit 900 includes a first set of two-qubit R_{zz} gates 904A at a second time step t₂, each of which is configured to generate entanglement across pairs of qubit devices 812 actively coupled by the first set of coupler devices 814A. The example quantum logic circuit 900 includes a second set of two-qubit R_{zz} gates 904B at a third time step t₃, each of which is configured to generate entanglement across pairs of qubit devices 812 actively coupled by the second set of coupler devices 814B. The example quantum logic circuit 900 includes a third set of two-qubit R_{zz} gates and SWAP gates 904C at a fourth time step t₄, each of which is configured to generate entanglement across pairs of qubit devices 812 actively coupled by the third set of coupler devices 814C.

The example quantum logic circuit 900 includes a fourth set of two-qubit R_{zz} gates 906A at a fifth time step t₅, each of which is configured to generate entanglement across pairs of qubit devices 812 actively coupled by the first set of coupler devices 814A. The example quantum logic circuit 900 includes a fifth set of two-qubit R_{zz} gates 906B at a sixth time step t₆, each of which is configured to generate entanglement across pairs of qubit devices 812 actively coupled by the second set of coupler devices 814B. The example quantum logic circuit 900 includes a sixth set of two-qubit R_{zz} gates and SWAP gates 906C at a seventh time step t₇, each of which is configured to generate entanglement across pairs of qubit devices 812 actively coupled by the third set of coupler devices 814C. The example quantum logic circuit 900 includes a seventh set of two-qubit R_{zz} gates 908A at an eighth time step t₈, each of which is configured to generate entanglement across pairs of qubit devices 812 actively coupled by the first set of coupler devices 814A. In some instances, the example quantum logic circuit 900 includes more sets of two-qubit R_{zz} gates and two-qubit R_{zz}/SWAP gates at different times.

The example quantum logic circuit 900 includes a first set of single-qubit quantum logic gates (Rz) 910 about the z axis Rz(θ∈ [symbol] )=exp(−iZθ/2) at a nineth time step t₉, e.g., single rotation operations. The example quantum logic circuit 900 includes a second set of single-qubit quantum logic gates (Rx) 912 about the x axis Rx(ϕ∈ [symbol] )=exp(−iXϕπ/4) at a tenth time step t₁₀, e.g., single rotation operations. The qubits of the qubit devices are then measured at an eleventh time step t₁₁. X, Y, and Z are Pauli operators. The qubit devices 812 of the quantum processing unit 804 have an average relaxation time T₁=25(2) μs, an average dephasing time T₂=28(2) μs, an average readout fidelity of 94.6 (7) %, and an average one-qubit Rx fidelity of 99.4 (2) % estimated by randomized benchmarking.

In some instances, a quantum logic gate, when applied to distinct quantum circuit devices, may be operated simultaneously during the same time step. Using the quantum processing unit 804 in FIG. 8 as an example, a two-qubit quantum logic gate in the first set 904A can be applied to qubit devices 2 and 4 by activating a respective coupler device 814A, deactivating coupler devices 814B, 814C to isolate the qubit devices 1 and 3 from the qubit device 2, deactivating coupler devices 814A, 814B to isolate the qubit device 5, 72 from the qubit device 4; a two-qubit quantum logic gate in the second set 904B can be applied to qubit devices 2 and 3 by activating a respective coupler device 814B, deactivating respective coupler devices 814A, 814C to isolate the qubit devices 1 and 4 from the qubit device 2; and a two-qubit quantum logic gate in the third set 904C can be applied to qubit devices 1 and 2 by activating a respective coupler device 814C, deactivating respective coupler devices 814A, 814B to isolate the qubit devices 3 and 4 from the qubit device 2.

In some instances, the quantum logic gates in the example single-layer QAOA quantum logic circuit 900 can be further decomposed into the hardware native gate set. For instance, the single-qubit quantum logic gate Rx(ϕ) is implemented for arbitrary angles using the standard “ZXZXZ” decomposition. Both Rzz(φ) and Rzz(φ)×SWAP gate can be implemented using hardware-native single-qubit quantum logic gates and at most two and three two-qubit \sqrt{iSWAP} gates, respectively; the precise decomposition is given in the Supplementary Information of the reference (“Quantum Enhanced Greedy Solver for Optimization Problems”, arXiv: 2303.05509v1 [quantum-ph], Mar. 9, 2023), which is hereby incorporated by reference in the present disclosure.

At each iteration of the algorithm, the problem is randomly mapped to the hardware-native architecture, and only gates involving qubits connected within 2 SWAP cycles are considered, with the others dismissed. The quantum logic circuit shown in FIG. 9 is compiled into hardware-native gates, resulting in about 400 native \sqrt{iSWAP} two-qubit quantum logic gates for the largest problems considered. A total of [symbol] =256 bit strings for all steps [symbol] are collected.

The quantum-enhanced greedy algorithm to solve a set of 10 random SK problem instances for sizes N=8, 24, 40, 56, and 72. One variable (K=1) is frozen at a time and use two-body expectation values to inform the selection process. The estimated expectation value of the approximation ratior≡ [symbol] r [symbol] _{γ*,β*} by computing the expectation value of the corresponding objective function over all sampled candidate bit string solutions at angles γ* and β*. For N≤24, brute force can be used to compute Cₘₐₓ and Cₘᵢₙ for a given problem instance, where Cₘₐₓ and Cₘᵢₙ are maximum cost value and minimum cost value. For larger N, the cost of the optimal solution is self-averaging, known exactly for N→+∞, and that finite-size corrections have also been studied over an ensemble of random instances. This gives access to a proxy for approximating r, assuming one is not interested in the performance for an individual problem but that of an ensemble.

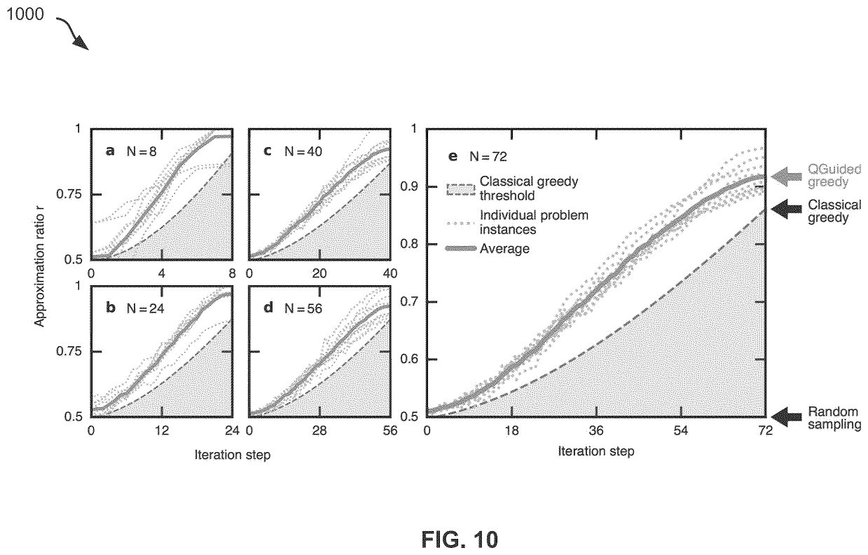

FIG. 10 is an exemplary plot 1000 showing the approximation ratio as a function of the iteration step for different models including a random sampling algorithm, a classical greedy algorithm, and a quantum-guided greedy algorithm. The random sampling algorithm leads to an average approximation ratio r=0.5. The performance of the classical greedy algorithm, evaluated from the average performance of 100 randomly generated problem instances of size N is represented by the shaded region with an average approximation ratio of about 0.85 for N approaches infinity. As shown in FIG. 10, for all sizes, the approximation ratio from the quantum-guided greedy algorithm is above the approximation ratio value of r=0.5 obtained using the random sampling strategy; and its average performance is systematically above that of the classical greedy baseline.

As shown in FIG. 10, the obtained approximation ratio as a function of the iteration step. Iteration step 0 corresponds to a truncated one-layer QAOA ansatz run on the initial problem of N variables. For all sizes, this is slightly above the r=½ random sampling bar, emphasizing that the QAOA displays a low average performance on current hardware. The last step corresponds to the final solution of the quantum-enhanced greedy algorithm. Its average performance is systematically above that of the classical greedy baseline. The approximation ratio in both the classical greedy and the quantum-enhanced algorithms have a distribution around the average. This is more evident at small N, for example N=8 and N=24, where the quantum greedy results for some problem instances dip below the average classical greedy results.

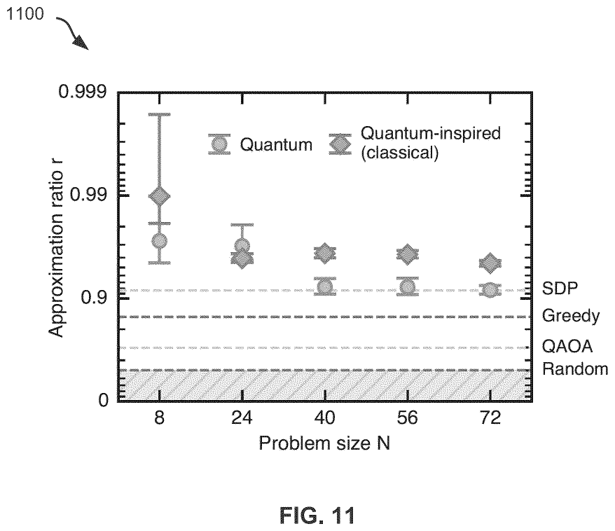

FIG. 11 is an exemplary plot 1100 showing the approximation ratio at the last step as a function of problem size N for different models including a random sampling algorithm, a classical greedy algorithm, and a quantum-guided greedy algorithm. A decrease in performance is observed with increasing problem size, which has two primary causes. First, the larger the size, the larger the quantum circuit, leading to a higher error rate. Second, the phase separator unitary of the truncated QAOA ansatz only covers an O(1/N) density of edges of the graph problem, which accounts for a vanishing fraction of two-body terms in the SK problem instances (about 3% for N=72). For comparison, a noiseless simulation of a nontruncated standard single-layer QAOA quantum logic circuit leads to an average approximation ratio r=½+¼P\sqrt{e}≃0.698688 . . . on large SK problem instances, where P is the Parisi constant.

As the quantum-enhanced greedy algorithm iteratively reduces the size of the problem and thus the number of qubits at each iteration step, smaller and smaller subsets of qubits are successively targeted with higher and higher overall quality.

Embedding the QAOA into the quantum-enhanced algorithm greatly enhances the quality of the end result. From step 0 to step N of the iterative loop, a 6 to 7 fold increase in the average approximation ratio for N=72 are obtained experimentally, where 1−r≃0.49→0.08. A fairer comparison point is the classical greedy baseline which runs the same algorithm with random bit strings as input instead. For the SK problem instances considered here, the expected approximation ratio of this classical heuristic is r≃0.848497 . . . as N→+∞. It is a high absolute bar to pass, much higher than what that obtained from a noisy and truncated one-layer QAOA run at iteration step 0. For reference, it requires at least a perfectly executed nontruncated four- to five-layer QAOA circuit to meet this classical performance (see Supplementary Information of the reference (“Quantum Enhanced Greedy Solver for Optimiztaion Problems”, arXiv: 2303.05509v1 [quantum-ph], Mar. 9, 2023)). Here, the quantum-enhanced greedy algorithm run on noisy quantum hardware improves upon the average approximation ratio of its classical counterpart by about a factor 2 (1−r≃0.151503 . . . →0.08) for the largest problem size N=72, empirically confirming the intuition that better-than-random bit strings should, on average, help make better-informed decisions in the freezing process. An explanation is that while bit strings look close to random as a whole because of noise, they might still locally retain relevant information. Here, the most correlated variable can be selected, as this suggests a well-defined value for the corresponding bit, making it a good candidate for freezing. An absolute performance comparable with state-of-the-art semidefinite programming method (SDP) can be achieved, corresponding to a spectral relaxation rounding to ±1 each entry of the leading eigenvector of the adjacency matrix of the graph problem.

The freezing decisions have a classical component that can be adapted to deal with some hard constraints; such as post-selecting on valid solutions. Hard constraints are ubiquitous in real-world optimization problems and are notoriously difficult to handle in practice. A possible strategy is to design quantum circuits working within the in-constraint space with dynamics restricted to the subspace of feasible solutions, but these methods may require greater quantum resources. Another typical approach uses penalty terms that will disfavor the appearance of out-of-constraint bit strings, but implementing them on near-term devices and tuning their strength can be similarly challenging. Here, the idea is to make only freezing decisions which do not violate any constraints. In some implementations, the had constraints, as a general satisfiability problem, is NP-complete. As an example, the iterative process with each iteration shown in the example process 700 of FIG. 7 is implemented on a portfolio optimization problem with hard constraints. In this case, the quantum-guided greedy algorithm used in the example process shown in FIG. 5 is modified to account for the hard constraints. The freezing decision is such that if setting a variable to a classical value makes the solution invalid, the other value is selected despite its higher cost. This makes it possible to classically filter bit strings output from the QAOA.

The goal of portfolio optimization problems is to build a portfolio maximizing the potential return while minimizing the volatility from a given basket of N assets. Whether an asset is selected for the portfolio is encoded as a binary variable. Without entering into the details, the problem takes the form of minimizing an objective function with binary variables and nonzero scalar parameters vᵢ and wᵢⱼ, as per the definition of the cost function. the objective function,

$$C = u + {\sum }_{i = 1}^{N} {v}_{i} {Z}_{i} + {\sum }_{j < i}^{N} {w}_{ij} {Z}_{i} {Z}_{j} , \qquad [ 4 ]$$

where u, vᵢ, and wᵢⱼ are problem-specific scalar parameters, and Zᵢ∈{−1, +1} are Ising spin variables with corresponding bit values Bᵢ=½−Zᵢ/2∈{0,1}. The goal is to find a bit string B=(B₁, B₂, . . . , B_{N}) minimizing Eq. (4). In addition to the minimization, there are two hard constraints on what makes a valid portfolio. They are of the form,

$${\sum }_{i = 1}^{N} {Z}_{i} \leq A , \qquad [ 5 ]$$

$${\sum }_{i = 1}^{N} {μ}_{i} {Z}_{i} \geq B , with A , B , {μ}_{i} ∈ ℝ$$

The first inequality constrains the maximum size of the portfolio and the second one the minimum expected return from the portfolio. The parameters A, B, and μᵢ are provided as part of the problem.

The hard constraints of Eq. (5) can be enforced classically as part of the quantum-enhanced greedy algorithm, thus ensuring that the final bit string is necessarily a valid solution. Moreover, it is not required to introduce auxiliary slack variables to map the inequalities into equalities, making the algorithm even more friendly for near term quantum devices.

In the freezing step (during operation 712), a variable otherwise identified as being a candidate for freezing, will not be frozen if it would take the potential final solution out of the space of valid bit strings. However, this may only be possible for certain types of constraints, including those of Eq. (5). Different strategies can be envisioned to adapt the freezing decision process. For instance, if freezing to a classical value is not possible, then the other value can be selected despite its higher cost. One could also go back to the election step (operation 710) and select another variable for freezing.

Whereas the hard-constraints will be fulfilled independently of the underlying quantum-based algorithm (e.g., QAOA or adiabatic quantum evolution), it might be advantageous for these algorithms to favor in-constraint bit strings for their output. A possible approach is to design quantum-logic circuits working within the in-constraint space, and more specifically for Hamming constrained problems, but it is practically infeasible on current quantum hardware due to noise. Another typical approach uses penalty terms that will disfavor the appearance of out-of-constraint bit strings (during operation 712). Another strategy might be to classically filter the out-of-constraint bit strings (during operation 708) returned by the quantum-based algorithm, if any.

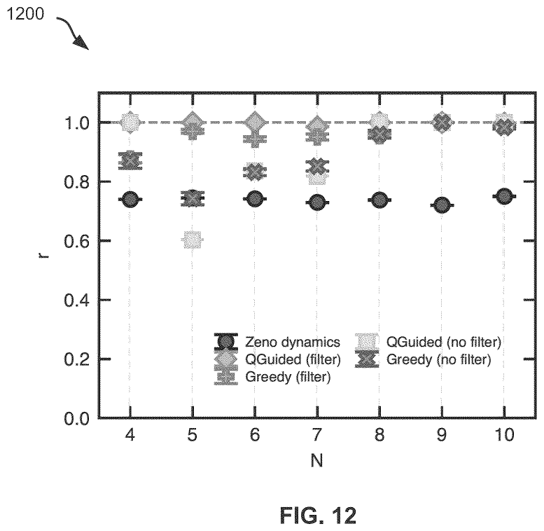

In some instances, Zeno dynamics can be embedded into QAOA to deal with hard-constraints in the form of Eq. (5). A problem of each size N=4, . . . , 10 can be generated and solved it using a one-layer QAOA circuit with Zeno dynamics. The corresponding data points are reported in FIG. 12, with an approximation ratio of about r≃0.74, independent of N. Here, the approximation ratio is defined with respect to the best and worst solutions of the in-constraint space.

On the exact same set of problems, the quantum-enhanced greedy algorithm shown in FIG. 7 and a single-layer QAOA quantum logic circuit shown in FIG. 9 are used. Two-body expectation values are used to inform the selection process. The freezing decision is such that if setting a variable to a classical value makes the solution invalid, the other value is selected despite its higher cost. The constraints on all problem instances are relatively loose since bit strings drawn at random have more than a 50% chance of being valid. This makes it possible to classically filter bit strings outputted from the QAOA. Here, filtering means discarding bit strings not fulfilling the hard constraints of Eq. (5). For example, an N-bit string {1, 1, 1, 1, . . . 1} will not fulfill the first constraint of Eq. (5) Σᵢ₌₁^{N} Zᵢ≤A for A=N/2 as Σᵢ₌₁^{N} Zᵢ=N. Such a bit string would be discarded.

FIG. 12 is an exemplary plot 1200 showing the approximation ratio as a function of the size of the problem for different models including a Zeno dynamic embedded QAOA algorithm, quantum-guided greedy algorithms with and without hard constraints (filter), and classical greedy algorithms with and without hard constraints (filter). As shown in FIG. 12, the quantum-guided algorithm with hard constraints by performing operation 708, e.g., filtering the out-of-constraint bit strings by classically discarding them before starting the selection process, can lead to better performance. As shown in FIG. 12, the classical greedy baseline systematically outperforms the single-layer QAOA quantum logic circuit with Zeno dynamics data and that it has a very high approximation ratio r≳0.95 for the sizes considered.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

In a general aspect, hybrid quantum systems capable of utilizing quantum computing to assist the execution of programs embodying greedy algorithms are presented.

In a first example, a method for generating an output of an optimization problem includes causing, via a communication channel, a quantum resource to execute a quantum-based algorithm corresponding to the optimization problem; obtaining, via the communication channel, quantum results based on data generated by the execution of the quantum-based algorithm, the quantum results being indicative of one or more solutions to the optimization problem as determined by the quantum-based algorithm; based on the quantum results, selecting, by a classical computing system, an unassigned element of the output; determining, by the classical computing system, a value for the selected unassigned element of the output; and returning the output with the determined value.

Implementations of the first example may include one or more of the following features. The quantum resource includes a hybrid computing system, and the quantum-based algorithm includes a quantum approximate optimization algorithm (QAOA) executed by the hybrid computing system. The quantum resource includes a hybrid computing system, and the quantum-based algorithm includes a variational quantum eigensolver (VQE) algorithm executed by a hybrid computing system. The optimization problem includes a quadratic binary optimization (QUBO) problem. The method includes determining, by the classical computing system, the value for the selected unassigned element of the output based on the one or more solutions indicated by the quantum results.

Implementations of the first example may include one or more of the following features. Determining the value reduces a number of unassigned elements of the output. The method includes after determining the value for the selected unassigned element, identifying a reduced optimization problem based on the reduced number of unassigned elements of the output; and causing, via the communication channel, the quantum resource to execute a quantum-based algorithm corresponding to the reduced optimization problem. The method includes performing an iterative process to determine values for all elements of the output. Each iteration of the iterative process includes identifying an optimization problem for the iteration based on a current number of unassigned elements of the output; causing, via the communication channel, the quantum resource to execute a quantum-based algorithm corresponding to the optimization problem for the iteration; obtaining, via the communication channel, quantum results for the iteration based on data generated by the execution of the quantum-based algorithm corresponding to the optimization problem for the iteration; based on the quantum results for the iteration, selecting, by the classical computing system, one of the unassigned elements for the iteration; and determining, by the classical computing system, a value for the selected unassigned element for the iteration.

Implementations of the first example may include one or more of the following features. Determining a value for the selected unassigned element of the output includes determining a second value. The method includes determining, by the classical computing system, a first value for the selected unassigned element of the output; and after rejecting the first value based on a hard constraint for the optimization problem, determining the second value. Obtaining the quantum results includes obtaining initial quantum results indicative of a plurality of solutions to the optimization problem as determined by the quantum-based algorithm; and selecting the one or more solutions from the plurality of solutions based on a hard constraint for the optimization problem.

Implementations of the first example may include one or more of the following features. The method includes determining, by the classical computing system, the value for the selected unassigned element of the output based on a scoring function associated with the optimization problem. The scoring function includes penalty terms based on a hard constraint for the optimization problem. Determining the value for the selected unassigned element of the output based on the scoring function includes determining respective scores for possible values of the selected unassigned element based on the quantum results and the scoring function; and selecting the value from the possible values based on the scores. Determining respective scores for possible values includes iteratively: temporarily assigning one of the possible values to the selected unassigned element in each of the one or more solutions; and computing the score for the temporarily assigned possible value by applying the scoring function to the one or more solutions having the temporarily assigned possible value.

Implementations of the first example may include one or more of the following features. The quantum-based algorithm is configured to apply a hard constraint. The unassigned element includes a first unassigned element. The method includes before selecting the first unassigned element of the output, identifying a plurality of unassigned elements of the output; determining respective confidence values for the plurality of unassigned elements based on the quantum results; and selecting the first unassigned element of the output based on the confidence values.

Implementations of the first example may include one or more of the following features. The one or more solutions are bit strings. The selected unassigned element of the output comprises a bit, and the determined value for the selected unassigned element comprises a binary value. The method includes based on the quantum results, selecting, by the classical computing system, a plurality of unassigned elements of the output; determining, by the classical computing system, respective values for the selected plurality of unassigned elements of the output; and returning the output with the determined values.

In a second example, a computer system includes a communication interface; and classical computing resources. The classical computing resources include one or more classical processing units; and memory storing instructions that, when executed by the one or more classical processing units, cause the one or more classical processing units to perform the method of the first example.

Implementations of the second example may include one or more of the following features. The computer system includes the quantum resource. The quantum resource includes at least one of a quantum simulator, a quantum computing system, or a hybrid computing system.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A method for generating an output of an optimization problem, the method comprising:
causing, via a communication channel, a quantum resource to execute a quantum-based algorithm corresponding to the optimization problem;
obtaining, via the communication channel, quantum results based on data generated by the execution of the quantum-based algorithm, the quantum results being indicative of one or more solutions to the optimization problem as determined by the quantum-based algorithm;
based on the quantum results, selecting, by a classical computing system, an unassigned element of the output;
determining, by the classical computing system, a value for the selected unassigned element of the output; and
returning the output with the determined value.

2. The method of claim 1, wherein the quantum resource comprises a hybrid computing system and the quantum-based algorithm comprises a quantum approximate optimization algorithm (QAOA) executed by the hybrid computing system.

3. The method of claim 1, wherein the quantum resource comprises a hybrid computing system and the quantum-based algorithm comprises a variational quantum eigensolver (VQE) algorithm executed by a hybrid computing system.

4. The method of claim 1, wherein the optimization problem comprises a quadratic binary optimization (QUBO) problem.

5. The method of claim 1, comprising determining, by the classical computing system, the value for the selected unassigned element of the output based on the one or more solutions indicated by the quantum results.

6. The method of claim 1, wherein determining the value reduces a number of unassigned elements of the output, and the method comprises, after determining the value for the selected unassigned element:
identifying a reduced optimization problem based on the reduced number of unassigned elements of the output; and
causing, via the communication channel, the quantum resource to execute a quantum-based algorithm corresponding to the reduced optimization problem.

7. The method of claim 6, comprising performing an iterative process to determine values for all elements of the output, wherein each iteration of the iterative process comprises:
identifying an optimization problem for the iteration based on a current number of unassigned elements of the output;
causing, via the communication channel, the quantum resource to execute a quantum-based algorithm corresponding to the optimization problem for the iteration;
obtaining, via the communication channel, quantum results for the iteration based on data generated by the execution of the quantum-based algorithm corresponding to the optimization problem for the iteration;
based on the quantum results for the iteration, selecting, by the classical computing system, one of the unassigned elements for the iteration; and
determining, by the classical computing system, a value for the selected unassigned element for the iteration.

8. The method of claim 1, wherein determining a value for the selected unassigned element of the output comprises determining a second value, and the method comprises:
determining, by the classical computing system, a first value for the selected unassigned element of the output; and
after rejecting the first value based on a hard constraint for the optimization problem, determining the second value.

9. The method of claim 1, wherein obtaining the quantum results comprises:
obtaining initial quantum results indicative of a plurality of solutions to the optimization problem as determined by the quantum-based algorithm;
selecting the one or more solutions from the plurality of solutions based on a hard constraint for the optimization problem.

10. The method of claim 1, comprising determining, by the classical computing system, the value for the selected unassigned element of the output based on a scoring function associated with the optimization problem.

11. The method of claim 10, wherein the scoring function comprises penalty terms based on a hard constraint for the optimization problem.

12. The method of claim 10, wherein determining the value for the selected unassigned element of the output based on the scoring function comprises:
determining respective scores for possible values of the selected unassigned element based on the quantum results and the scoring function; and
selecting the value from the possible values based on the scores.

13. The method of claim 12, wherein determining respective scores for possible values comprises iteratively:
temporarily assigning one of the possible values to the selected unassigned element in each of the one or more solutions; and
computing the score for the temporarily assigned possible value by applying the scoring function to the one or more solutions having the temporarily assigned possible value.

14. The method of claim 1, wherein the quantum-based algorithm is configured to apply a hard constraint.

15. The method of claim 1, wherein the unassigned element comprises a first unassigned element, and the method comprises:
before selecting the first unassigned element of the output, identifying a plurality of unassigned elements of the output;
determining respective confidence values for the plurality of unassigned elements based on the quantum results; and
selecting the first unassigned element of the output based on the confidence values.

16. The method of claim 1, wherein the one or more solutions are bit strings, the selected unassigned element of the output comprises a bit, and the determined value for the selected unassigned element comprises a binary value.

17. The method of claim 1, comprising:
based on the quantum results, selecting, by the classical computing system, a plurality of unassigned elements of the output;
determining, by the classical computing system, respective values for the selected plurality of unassigned elements of the output; and
returning the output with the determined values.

18. A computer system comprising:
a communication interface; and
classical computing resources comprising:
one or more classical processing units; and
memory storing instructions that, when executed by the one or more classical processing units, cause the one or more classical processing units to perform operations comprising:
causing, via a communication channel, a quantum resource to execute a quantum-based algorithm corresponding to the optimization problem;
obtaining, via the communication channel, quantum results based on data generated by the execution of the quantum-based algorithm, the quantum results being indicative of one or more solutions to the optimization problem as determined by the quantum-based algorithm;
based on the quantum results, selecting, by a classical computing system, an unassigned element of the output;
determining, by the classical computing system, a value for the selected unassigned element of the output; and
returning the output with the determined value.

19. The computer system of claim 18, comprising the quantum resource, wherein the quantum resource comprises at least one of a quantum simulator, a quantum computing system, or a hybrid computing system.
